(19) United States
(12) Patent Application Publication
(10) Pub. No.: US 2026/0137973 A1
(43) Pub. Date: May 21, 2026

(54) EXERCISE ASSISTANCE DEVICE

(71) Applicant: SAMSUNG ELECTRONICS CO., LTD., Suwon-si (KR)

(72) Inventors: Seunghoon OH, Suwon-si (KR); Huu Lam Vuong NGUYEN, Suwon-si (KR); Namki SUL, Suwon-si (KR); Yongho SO, Suwon-si (KR)

(21) Appl. No.: 19/448,366

(22) Filed: Jan. 14, 2026

Related U.S. Application Data
(63) Continuation of application No. PCT/KR2024/006577, filed on May 14, 2024.

(30) Foreign Application Priority Data
Jul. 24, 2023 (KR) 10-2023-0095848

(51) Int. Cl. A63B 21/00; A61H 1/02

(52) U.S. Cl. CPC A63B 21/00181; A61H 1/0244; A61H 2201/163; A61H 2201/1642; A61H 2201/1652

(57) ABSTRACT

An exercise assistance device may include: a waist frame worn on the waist of a user; a first waist belt, which is connected to one side of the waist frame and covers the front of the waist of the user; a second waist belt, which is connected to the other side of the waist frame and covers the front of the waist of the user; a force transmission frame for covering the front of the thigh of the user; a thigh belt, which is connected to the force transmission frame and wraps around the thigh of the user; an actuator, which is connected to the waist frame and generates power; a driving frame, which is connected to the actuator and transmits the power to the force transmission frame; a buckle plug connected to the first waist belt; and a buckle socket connected to the second waist belt, wherein the buckle plug can move in a first direction, which is the direction in which the buckle plug is inserted into the buckle socket, and can be switched between an intermediate fastening state in which the buckle plug can be locked at the first position of the buckle socket and a complete fastening state in which the buckle plug can be locked at a second position spaced in the first direction from the first position of the buckle socket.

### CROSS-REFERENCE TO RELATED APPLICATIONS

This application is a continuation application of International Application No. PCT/KR2024/006577, filed on May 14, 2024, in the Korean Intellectual Property Receiving Office, and claiming priority to KR Application No. 10-2023-0095848 filed Jul. 24, 2023, the disclosures of which are all hereby incorporated by reference herein in their entireties.

### TECHNICAL FIELD

Certain example embodiments may relate to an exercise assistance device.

### BACKGROUND

In a rapidly aging society, a growing number of people are complaining of joint-related inconvenience and pain. Accordingly, there is a heightened interest in an assistance device for assisting the elderly or other patients having joint problems or who desire exercise. An exercise assistance device may also be worn to increase muscular strength of a specific body part(s).

### SUMMARY

An exercise assistance device according to an example embodiment may include a waist frame worn on a waist of a user, a first waist belt connected, directly or indirectly, to one side of the waist frame and covering a front side of the waist of the user, a second waist belt connected, directly or indirectly, to the other side of the waist frame and covering a front side of the waist of the user, a force transmission frame covering a front side of a thigh of the user, a thigh belt connected, directly or indirectly, to the force transmission frame and surrounding the thigh of the user, an actuator connected, directly or indirectly, to the waist frame and generating power, a driving frame connected, directly or indirectly, to the actuator and transmitting the power to the force transmission frame, a buckle plug connected, directly or indirectly, to the first waist belt, and a buckle socket connected, directly or indirectly, to the second waist belt, wherein the buckle plug moves in a first direction in which the buckle plug is inserted into the buckle socket, and switches its state between an intermediate fastened state in which the buckle plug is engaged at a first position of the buckle socket and a fully fastened state in which the buckle plug is engaged at a second position of the buckle socket provided at a position apart from the first position in the first direction.

A buckle assembly according to an example embodiment may include a buckle plug and a buckle socket detachable from the buckle plug, wherein the buckle plug switches its state between an intermediate fastened state in which the buckle plug is engaged at a first position of the buckle socket and a fully fastened state in which the buckle plug is engaged at a second position of the buckle socket provided at a position apart from the first position in the first direction.

An exercise assistance device according to an example embodiment may include a waist frame worn on a waist of a user, a first waist belt connected, directly or indirectly, to one side of the waist frame and covering a front side of the waist of the user, a second waist belt connected, directly or indirectly, to the other side of the waist frame and covering a front side of the waist of the user, a buckle plug connected, directly or indirectly, to the first waist belt, and a buckle socket including a pair of guides connected, directly or indirectly, to the second waist belt and guiding the buckle plug in one direction, a pair of intermediate fastening parts respectively extending from the pair of guides and engaged with the buckle plug, a pair of fully fastening parts respectively extending from the pair of intermediate fastening parts and engaged with the buckle plug, wherein the buckle plug switches its state between an intermediate fastened state engaged with the pair of intermediate fastening parts and a fully fastened state engaged with the pair of fully fastening parts, a length of the first waist belt is adjustable in the intermediate fastened state, and the first waist belt is pressed by the buckle socket and the buckle plug in the fully fastened state.

### BRIEF DESCRIPTION OF DRAWINGS

FIG. 1 is a perspective view of a user wearing an exercise assistance device according to an example embodiment.

FIG. 2 is a perspective view of a buckle plug, a buckle socket, a first waist belt, and a second waist belt according to an example embodiment.

FIG. 3 is a perspective view of a base frame, a cover frame, and a buckle plug according to an example embodiment.

FIG. 4 is a plan view of a base frame and a buckle plug in an intermediate fastened state according to an example embodiment.

FIG. 5 is a plan view of a base frame and a buckle plug in a fully fastened state according to an example embodiment.

FIG. 6 is a cross-sectional view of a buckle socket, a buckle plug in an intermediate fastened state, and a first waist belt according to an example embodiment.

FIG. 7 is a cross-sectional view of a buckle socket, a buckle plug in a fully fastened state, and a first waist belt according to an example embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Terms, such as “first”, “second”, and the like may be used herein to describe components. Each of these terminologies is not used to define an essence, order or sequence of a corresponding component but used merely to distinguish the corresponding component from other component(s). For example, a first component may be referred to as a second component, and similarly, the second component may also be referred to as the first component.

It should be noted that if it is described that one component is “connected”, “coupled”, or “joined” to another component, at least a third component(s) may be “connected”, “coupled”, and “joined” between the first and second components, although the first component may be directly connected, coupled, or joined to the second component. Thus, “connected” as used herein covers both direct and indirect connections.

As used herein, the singular form is intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

The same name may be used to describe an element included in the embodiments described above and an element having a common function. Unless otherwise mentioned, the description of one embodiment may be applicable to other embodiments. Thus, duplicated description is omitted for conciseness.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

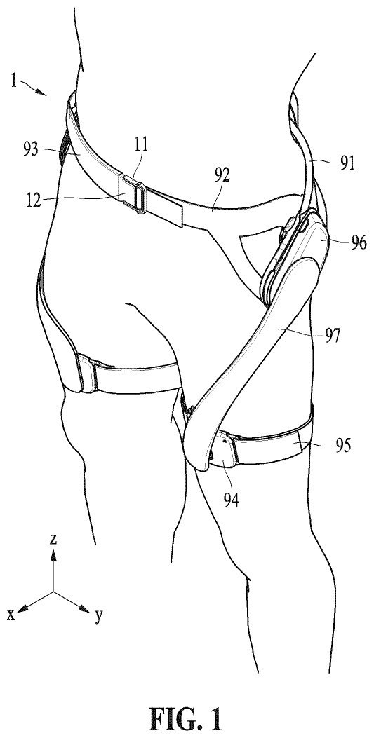

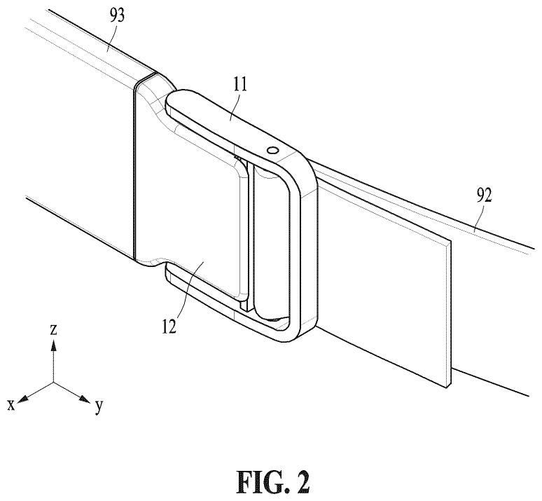

FIG. 1 is a perspective view of a user wearing an exercise assistance device according to an embodiment, and FIG. 2 is a perspective view of a buckle plug, a buckle socket, a first waist belt, and a second waist belt according to an embodiment.

Referring to FIGS. 1 and 2, an exercise assistance device 1 according to an embodiment may be worn by a user to assist a motion of the user. The user may be a human being or a robot, but is not limited thereto. The exercise assistance device 1 may assist a motion of a joint of a lower body or upper body. For example, the exercise assistance device 1 may assist a lower body motion by assisting at least one joint of a hip joint, a knee joint, and an ankle joint. The exercise assistance device 1 may include a waist frame 91, a first waist belt 92, a second waist belt 93, a force transmission frame 94, a thigh belt 95, an actuator 96, a driving frame 97, a buckle plug 11, and a buckle socket 12.

In this case, the waist frame 91, the first waist belt 92, and the second waist belt 93 may configure a waist-worn part. In addition, the force transmission frame 94 and the thigh belt 95 may configure a thigh-worn part.

In an embodiment, the waist-worn part and the thigh-worn part may be disposed on opposite sides based on a part of the user and may be respectively worn on a proximal part and a distal part. For example, the waist-worn part may surround the waist and/or pelvis, and the thigh-worn part may surround a thigh, knee, calf, and/or foot.

In an embodiment, the waist frame 91 may be worn on the waist of the user. The first waist belt 92 and the second waist belt 93 may be connected, directly or indirectly, to the waist frame 91 and may surround a remaining part of the waist of the user. For example, the waist frame 91 may surround a rear side of the waist, and the first waist belt 92 and the second waist belt 93 may surround a front side of the waist.

In an embodiment, the first waist belt 92 may be connected, directly or indirectly, to one side of the waist frame 91, and the second waist belt 93 may be connected, directly or indirectly, to the other side of the waist frame 91. The first waist belt 92 and the second waist belt 93 may be connected via a buckle assembly. The buckle assembly may include the buckle plug 11 and the buckle socket 12.

In an embodiment, the buckle plug 11, also referred to as a male buckle, may be connected, directly or indirectly, to the first waist belt 92, and the buckle socket 12, also referred to as a female buckle, may be connected, directly or indirectly, to the second waist belt 93. In this structure, the user may adjust a length of the first waist belt 92 surrounding the waist of the user by pulling an end of the first waist belt 92 engaged with the buckle plug 11 toward one side of the waist frame 91. For example, when the user pulls the end of the first waist belt 92, the length of the first waist belt 92 surrounding the waist of the user may be shortened. As the length of the first waist belt 92 surrounding the waist of the user is shortened, a degree to which the first waist belt 92 and the second waist belt 93 tighten the waist of the user may increase. The exercise assistance device 1 may be worn tightly to fit waist circumferences of various users. The first waist belt 92 may be provided longer than a length of the second waist belt 93 for a comfortable length adjustment.

In an embodiment, the force transmission frame 94 may cover a front part of a thigh of the user. The thigh belt 95 may be connected to the force transmission frame 94 and may surround the thigh of the user.

In an embodiment, the waist-worn part and the thigh-worn part may relatively move on a sagittal plane. For example, when the user flexes or extends the hip joint while wearing the exercise assistance device 1, the thigh-worn part may rotate relative to the lumber-worn part on the sagittal plane.

In an embodiment, the waist-worn part and the thigh-worn part may relatively move on a frontal plane. For example, when the user performs hip joint adduction or abduction while wearing the exercise assistance device 1, the thigh-worn part may rotate relative to the waist-worn part on the frontal plane.

In an embodiment, the driving frame 97 and the thigh-worn part may relatively move on a transverse plane. For example, when the user rotates a thigh while wearing the exercise assistance device 1, the thigh-worn part may rotate together with the thigh while being in close contact with the thigh. The thigh-worn part may move relative to the driving frame 97. According to this structure, the wearability of the exercise assistance device 1 may be improved.

In an embodiment, the actuator 96 may be connected to the waist frame 91 and may generate power. The actuator 96 may include, for example, a motor and a decelerator. The motor may include at least one of a brush motor, a brushless motor, and a stepping motor. The motor may include at least one of an induction motor and a synchronous motor. The decelerator may include, for example, a gear train.

In an embodiment, the driving frame 97 may transmit the power generated by the actuator 96 to the force transmission frame 94. For example, the driving frame 97 may assist a hip joint motion of the user. When an output end of the actuator 96 rotates in one direction, the driving frame 97 may assist a flexion motion of the hip joint by receiving the power from the actuator 96. When the output end of the actuator 96 rotates in a direction opposite to the one direction, the driving frame 97 may assist an extension motion of the hip joint by receiving the power from the actuator 96.

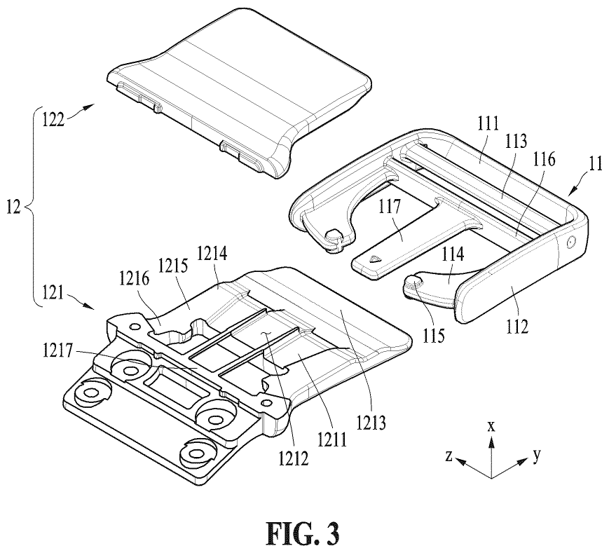

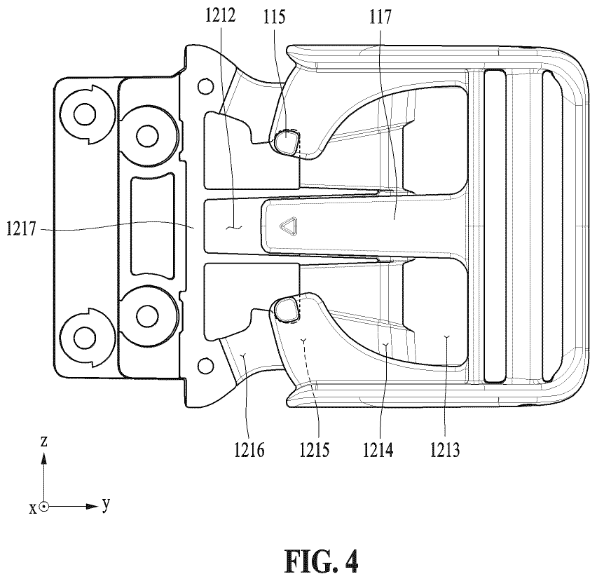

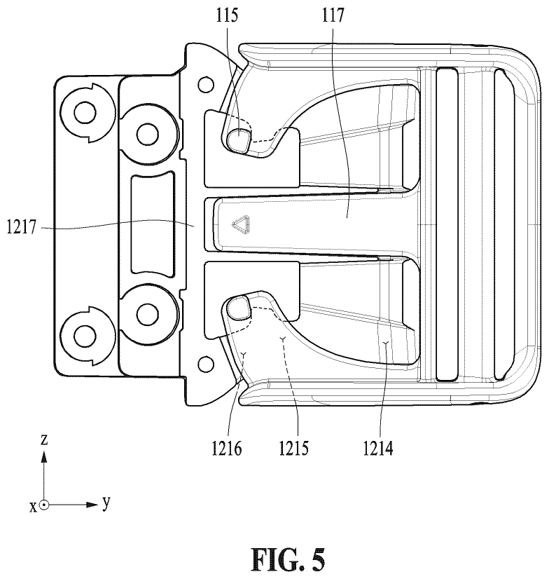

FIG. 3 is a perspective view of a base frame, a cover frame, and a buckle plug according to an embodiment. FIG. 4 is a plan view of a base frame and a buckle plug in an intermediate fastened state according to an embodiment, and FIG. 5 is a plan view of a base frame and a buckle plug in a fully fastened state according to an embodiment.

Referring to FIGS. 3 to 5, the buckle plug 11 according to an embodiment may be provided to switch its state between an intermediate fastened state engaged at a first position of the buckle socket 12 and a fully fastened state engaged at a second position of the buckle socket 12 spaced apart from the first position in a first direction. In this case, the first direction may be a direction in which the buckle plug 11 is inserted into the buckle socket 12 and may be a −y-axis direction.

In an embodiment, when the buckle plug 11 is in the intermediate fastened state, the user may adjust the length of the first waist belt surrounding the waist of the user by pulling or loosening an end of the first waist belt connected to the buckle plug 11. When the buckle plug 11 is in the fully fastened state, the first waist belt may be pressed by the buckle plug 11 and the buckle socket 12. After describing the structure of the buckle plug 11, the structure of the buckle socket 12 is described. The buckle plug 11 may include a plug base 111, a pair of plug arms 112, a holder 113, a pair of hooks 114, a pair of fastening protrusions 115, a support rib 116, and a center bar 117.

In an embodiment, the plug base 111 may cover a portion of the first waist belt in a width direction of the first waist belt. In this case, the width direction of the first waist belt is a z-axis direction. The pair of plug arms 112 may respectively extend from both ends of the plug base 111 in parallel.

In an embodiment, the pair of hooks 114 may respectively extend from the pair of plug arms 112 and may be engaged with the buckle socket 12. For example, the fastening protrusion 115 protruding in at least one of an upper direction or a lower direction may be provided on the pair of hooks 114. In this case, the upper and lower directions may be directions parallel to an x-axis direction. When the buckle plug 11 is in the first position and the second position, the fastening protrusion 115 may be engaged with a groove provided inside the buckle socket 12. As the fastening protrusion 115 is engaged with the groove, the buckle plug 11 may be fixed to the buckle socket 12.

In an embodiment, after the user presses the pair of plug arms 112 in directions facing each other, the user may separate the buckle plug 11 from the buckle socket 12. The pair of fastening protrusions 115 may be deviated from the groove formed inside the buckle socket 12, and a motion of the buckle plug 11 in the first direction and a second direction relative to the buckle socket 12 may not be restricted. In this case, the second direction may be a direction opposite to the first direction and may be a +y-axis direction.

In an embodiment, the support rib 116 may be connected to the pair of plug arms 112. The support rib 116 may support the pair of plug arms 112. When the user applies an excessive force to the pair of plug arms 112 to separate the buckle plug 11 from the buckle socket 12, the pair of plug arms 112 may be prevented from being damaged or damage chances reduced.

In an embodiment, the center bar 117 may extend from the support rib 116. The center bar 117 may be parallel to the pair of plug arms 112 and may be provided between the pair of hooks 114. In the buckle socket 12, the center bar 117 may guide a movement of the buckle plug 11 in the first direction and the second direction. For example, the center bar 117 may be inserted into a center groove 1212 formed inside the buckle socket 12.

In an embodiment, after the center bar 117 is inserted into the center groove 1212, a range in which the buckle plug 11 moves relative to the buckle socket 12 in a lateral direction may be restricted. In this case, the lateral direction may be a direction parallel to a z-axis. In this structure, when the buckle plug 11 is inserted into the buckle socket 12, the user may insert the center bar 117 into the center groove 1212 first and then may press the buckle plug 11 in the first direction.

In an embodiment, the holder 113 may be provided in parallel to the plug base 111 and may support the first waist belt. The first waist belt may enter a space between the support rib 116 and the holder 113 and then may escape to a space between the holder 113 and the plug base 111. A partial surface of the holder 113 may be covered by the first waist belt.

In an embodiment, the buckle socket 12 may include a base frame 121 and a cover frame 122. The base frame 121 may face the body of the user and may support the buckle plug 11. When the buckle plug 11 is in the fully fastened state, the cover frame 122 may be disposed on an opposite side of the base frame 121 based on the pair of hooks 114. The base frame 121 may be connected to a support 1217 formed on the base frame 121. The base frame 121 and the cover frame 122 may restrict a vertical movement of the buckle plug 11 fastened to the buckle socket 12.

In an embodiment, the base frame 121 may have a bent shape that surrounds the body of the user. The base frame 121 may protrude from a yz plane toward the +x direction. By this shape, when the user wears the exercise assistance device, a gap between the base frame 121 and the body of the user may decrease, and the wearability of the exercise assistance device may be improved.

In an embodiment, the base frame 121 may include a base body 1211 connected to a cover frame 122, the center groove 1212 provided at a center of the base body 1211, and a pressing plate 1213 extending from the base body 1211 in the second direction. When the buckle plug 11 is in the fully fastened state, the pressing plate 1213 may overlap the plug base 111 based on the x-axis direction.

In the structure described above, when the buckle plug 11 is switched from the intermediate fastened state to the fully fastened state, the pressing plate 1213 may guide a portion of the first waist belt passing between the plug base 111 and the pressing plate 1213 in the second direction. The pressing plate 1213 is further described below.

In an embodiment, a guide 1214, an intermediate fastening part 1215, a fully fastening part 1216, and a support 1217 may be formed on the base frame 121. When the buckle plug 11 is supported by the intermediate fastening part 1215, the buckle plug 11 may be in the intermediate fastened state. When the buckle plug 11 is supported by the fully fastened part 1216, the buckle plug 11 may be in the fully fastened state.

In an embodiment, the guide 1214 may protrude from the base frame 121 toward the cover frame 122. A pair of guides 1214 facing each other may be provided and may guide the buckle plug 11 to move in the first direction in the buckle socket 12. While the buckle plug 11 moves in the first direction, the pair of fastening protrusions 115 of the buckle plug 11 may respectively slide along the pair of guides 1214.

In an embodiment, a distance between the pair of guides 1214 may decrease toward the first direction. In this structure, as the buckle plug 11 moves in the first direction in the buckle socket 12, the distance between the pair of fastening protrusions 115 may decrease, and a degree of deformation of the pair of hooks 114 may increase.

In an embodiment, a pair of intermediate fastening parts 1215 may respectively extend from the pair of guides 1214 in the first direction. The intermediate fastening part 1215 may include a groove engaged with the fastening protrusion 115. When the buckle plug 11 moves in the first direction along the guide 1214 and is positioned at the first position, the fastening protrusion 115 may be engaged with a groove formed on the intermediate fastening part 1215 by a restoring force of the deformed hook 114. When the fastening protrusion 115 is engaged with the groove formed on the intermediate fastening part 1215, the hook 114 may be still deformed, and the fastening protrusion 115 may be supported by the intermediate fastening part 1215 by the restoring force of the hook 114. In this case, the buckle plug 11 may be in the intermediate fastened state. When an external force greater than or equal to specific magnitude is not applied, the movement of the buckle plug 11 in the first direction and the second direction relative to the buckle socket 12 may be restricted.

In an embodiment, a pair of fully fastening parts 1216 may respectively extend from the pair of intermediate fastening parts 1215 in the first direction. The fully fastening part 1216 may include a groove engaged with the fastening protrusion 115. In the intermediate fastened state, after the user removes the fastening protrusion 115 from the intermediate fastening part 1215 by pressing the pair of plug arms 112 in a direction facing each other, the user may move the buckle plug 11 in the first direction. When the buckle plug 11 moves in the first direction and is positioned at the second position, the fastening protrusion 115 may be engaged with a groove formed on the fully fastening part 1216 by the restoring force of the deformed hook 114.

In an embodiment, when the fastening protrusion 115 is engaged with the groove formed on the fully fastening part 1216, the hook 114 may be still deformed, and the fastening protrusion 115 may be supported by the fully fastening part 1216 by the restoring force of the hook 114. The movement of the buckle plug 11 in the second direction relative to the buckle socket 12 may be restricted. In this case, the buckle plug 11 may be in the fully fastened state.

In an embodiment, in the fully fastened state, the movement of the buckle plug 11 in the first direction relative to the buckle socket 12 may be restricted by the support rib 116. In the fully fastened state, a distance between the cover frame 122 and the base frame 121 positioned in the first direction based on the support rib 116 may be less than a length of the support rib 116 in the x-axis direction. In this structure, in the fully fastened state, when the buckle plug 11 is pressed in the first direction, the support rib 116 may be engaged between the base frame 121 and the cover frame 122. The support rib 116 may remain in a state supported by the buckle socket 12, and the movement of the buckle plug 11 in the first direction relative to the buckle socket 12 may be restricted. Contact between the center bar 117 and the support 1217 may be reduced, and noise caused by the contact may also be reduced.

The center groove 1212, the guide 1214, the intermediate fastening part 1215, the fully fastening part 1216, and the support 1217 are described as formed only on the base frame 121, but the center groove 1212, the guide 1214, the intermediate fastening part 1215, the fully fastening part 1216, and the support 1217 may be formed on at least one of the base frame 121 and the cover frame 122. For example, the guide 1214, the intermediate fastening part 1215, the fully fastening part 1216, and the support 1217 may be formed only on the cover frame 122. In this case, the fastening protrusion 115 may protrude from the hook 114 toward the +z direction. When the guide 1214, the intermediate fastening part 1215, the fully fastening part 1216, and the support 1217 are formed on both the base frame 121 and the cover frame 122, the fastening protrusion 115 may protrude from the hook 114 in the +z and −z directions.

The buckle socket 12 is described as separable into the base frame 121 and the cover frame 122, but the buckle socket 12 may have an integrated structure that is not separable into the base frame 121 and the cover frame 122.

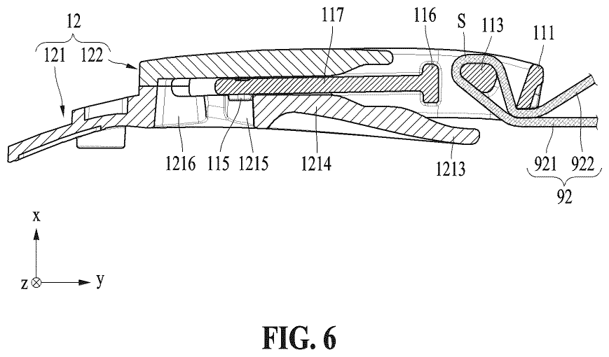

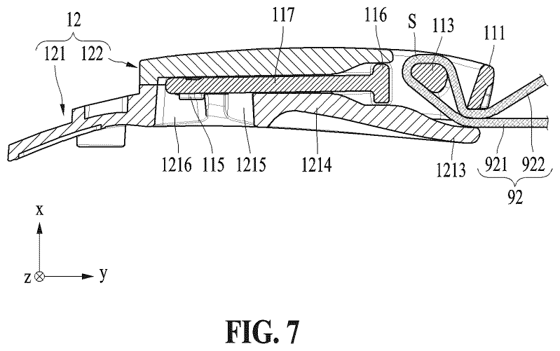

FIG. 6 is a cross-sectional view of a buckle socket, a buckle plug in an intermediate fastened state, and a first waist belt according to an embodiment, and FIG. 7 is a cross-sectional view of a buckle socket, a buckle plug in a fully fastened state, and a first waist belt according to an embodiment.

Referring to FIGS. 6 and 7, when the buckle plug in an embodiment is in the intermediate fastened state, the user may adjust the length of the first waist belt 92. Based on a point S where the first waist belt 92 is supported by, directly or indirectly, the holder 113, the first waist belt 92 may be divided into an inner belt 921 and an outer belt 922. The inner belt 921 may be a portion of the first waist belt 92 passing through the pressing plate 1213 and the plug base 111 and entering between the support rib 116 and the holder 113.

In an embodiment, the outer belt 922 may be a portion of the first waist belt 92 extending from the inner belt 921, escaping between the holder 113 and the plug base 111, and passing through the pressing plate 1213 and the plug base 111. For example, when the thickness of the first waist belt 92 is constant, the thickness of the inner belt 921 and the thickness of the outer belt 922 may be constant.

In an embodiment, when the fastening protrusion 115 is supported by the intermediate fastening part 1215, a distance between the pressing plate 1213 and the plug base 111 may be greater than a sum of the thickness of the inner belt 921 and the thickness of the outer belt 922. In this case, the thicknesses of the inner belt 921 and the outer belt 922 may be the thickness when an external force is not applied. The inner belt 921 and the outer belt 922 may not be pressed by the pressing plate 1213 and the plug base 111. In the intermediate fastened state, the user may pull or loosen the outer belt 922 relative to the holder 113 to adjust a degree to which the first waist belt 92 tightens the waist. The user may adjust the length of the first waist belt without completely separating the buckle plug in the fully fastened state from the buckle socket 12.

In an embodiment, when the buckle plug is in the fully fastened state, the first waist belt 92 may be guided in the second direction by the pressing plate 1213. The pressing plate 1213 may guide the outer belt 922 and the inner belt 921 passing between the pressing plate 1213 and the plug base 111, in the second direction. In other words, in the fully fastened state, the holder 113 may support the first waist belt in the −y direction.

In contrast, when the pressing plate 1213 does not exist, the first waist belt 92 may rotate around the holder 113 as a rotation axis and may be supported in the +x direction by the holder 113 due to a repetitive motion of the user. In this case, since the movement of the first waist belt 92 in the +x direction relative to the buckle plug is not restricted, when the first waist belt 92 moves in the +x direction, the holder 113 may be spaced apart from the first waist belt 92 surrounding the holder 113, and the first waist belt 92 may be released. The pressing plate 1213 may restrict a rotation angle of the first waist belt 92 that rotates around the holder 113 as the rotation axis and may reduce loosening of the first waist belt 92.

In an embodiment, in the fully fastened state, the distance between the pressing plate 1213 and the plug base 111 may be less than the distance between the pressing plate 1213 and the plug base 111 in the intermediate fastened state. In the fully fastened state, the distance between the pressing plate 1213 and the plug base 111 may be less than twice the thickness of the first waist belt 92. In other words, in the fully fastened state, the distance between the pressing plate 1213 and the plug base 111 may be less than the sum of the thicknesses of the inner belt 921 and the outer belt 922. In this case, the thicknesses of the inner belt 921 and the outer belt 922 may be the thickness when an external force is not applied.

In an embodiment, based on the x-axis direction, a distance between the cover frame 122 and the base frame 121 may be greater than the length of the center bar 117 and may be less than the length of the support rib 116. The support rib 116 may be restricted to move in the first direction as the support rib 116 is engaged between the cover frame 122 and the guide 1214. The movement of the buckle plug in the second direction relative to the buckle socket 12 may be restricted by the fully fastening part 1216. In the fully fastened state, the distance between the pressing plate 1213 and the plug base 111 may remain constant.

In the structure described above, in the fully fastened state, the inner belt 921 and the outer belt 922 may be kept being pressed by the pressing plate 1213 and the plug base 111. Even when the user wears the exercise assistance device for a long time or iteratively performs the same motion, the first waist belt 92 may tightly surround the waist of the user without being released from the buckle plug. The wearability of the exercise assistance device may be improved.

An exercise assistance device according to an embodiment may include a waist frame worn on a waist of a user, a first waist belt connected to one side of the waist frame and covering a front side of the waist of the user, a second waist belt connected to the other side of the waist frame and covering a front side of the waist of the user, a force transmission frame covering a front side of a thigh of the user, a thigh belt connected to the force transmission frame and surrounding the thigh of the user, an actuator connected to the waist frame and generating power, a driving frame connected to the actuator and transmitting the power to the force transmission frame, a buckle plug connected to the first waist belt, and a buckle socket connected to the second waist belt, wherein the buckle plug moves in a first direction in which the buckle plug is inserted into the buckle socket, and switches its state between an intermediate fastened state in which the buckle plug is engaged at a first position of the buckle socket and a fully fastened state in which the buckle plug is engaged at a second position of the buckle socket provided at a position apart from the first position in the first direction.

According to an embodiment, the buckle plug may include a plug base, a pair of plug arms respectively extending from both ends of the plug base in parallel, a holder provided in parallel to the plug base and supporting the first waist belt, a pair of hooks respectively extending from the pair of plug arms, and a pair of fastening protrusions respectively protruding from the pair of hooks and fastened to the buckle socket.

According to an embodiment, the first waist belt may pass between the plug base and the holder and may surround the holder.

According to an embodiment, the buckle socket may include a pair of guides guiding the buckle plug to move in the first direction, a pair of intermediate fastening parts respectively extending from the pair of guides and respectively supporting the pair of fastening protrusions in the intermediate fastened state, and a pair of fully fastening parts respectively extending from the pair of intermediate fastening parts and respectively supporting the pair of fastening protrusions in the fully fastened state.

According to an embodiment, a distance between the pair of guides may decrease toward the first direction.

According to an embodiment, the buckle socket may further include a base frame, and a cover frame disposed on an opposite side of the base frame based on the pair of hooks when the buckle plug is in the fully fastened state.

According to an embodiment, the pair of guides, the pair of intermediate fastening parts, and the pair of fully fastening parts may be provided on at least one of the base frame and the cover frame.

According to an embodiment, the base frame may include a base body connected to the cover frame, and a pressing plate extending from the base body in a second direction, which is a direction opposite to the first direction.

According to an embodiment, in the fully fastened state, the pressing plate may guide the first waist belt, which passes between the pressing plate and the plug base, in the second direction.

According to an embodiment, a distance between the pressing plate and the plug base in the intermediate fastened state may be greater than a distance between the pressing plate and the plug base in the fully fastened state.

According to an embodiment, in the fully fastened state, a distance between the pressing plate and the plug base may be less than twice a thickness of the first waist belt.

According to an embodiment, the buckle plug may include a support rib connected to the pair of plug arms and provided on an opposite side of the plug base based on the holder, and a center bar extending from the support rib in a direction parallel to the pair of plug arms.

According to an embodiment, the first waist belt may include an inner belt passing between the support rib and the holder and an outer belt passing between the holder and the plug base, based on a point supported by, directly or indirectly, the holder, and in the fully fastened state, a distance between the pressing plate and the plug base is less than a sum of a thickness of the inner belt and a thickness of the outer belt.

According to an embodiment, in the fully fastened state, the support rib may be supported by, directly or indirectly, the buckle socket.

According to an embodiment, in the intermediate fastened state, a length of the first waist belt may be adjustable, and in the fully fastened state, the first waist belt may be pressed by the buckle socket and the buckle plug.

A buckle assembly according to an embodiment may include a buckle plug and a buckle socket detachable from the buckle plug, wherein the buckle plug switches its state between an intermediate fastened state in which the buckle plug is engaged at a first position of the buckle socket and a fully fastened state in which the buckle plug is engaged at a second position of the buckle socket provided at a position apart from the first position in the first direction.

According to an embodiment, the buckle plug may include a plug base, a pair of plug arms respectively extending from both ends of the plug base in parallel, a holder provided in parallel to the plug base and supporting the first waist belt, a pair of hooks respectively extending from the pair of plug arms, and a pair of fastening protrusions respectively protruding from the pair of hooks and fastened to the buckle socket.

According to an embodiment, in the intermediate fastened state, the length of the first waist belt may be adjustable, and in the fully fastened state, the first waist belt may be pressed by the buckle socket and the buckle plug.

According to an embodiment, the buckle socket may include a pair of guides guiding the buckle plug to move in the first direction, a pair of intermediate fastening parts respectively extending from the pair of guides and respectively supporting the pair of fastening protrusions in the intermediate fastened state, and a pair of fully fastening parts respectively extending from the pair of intermediate fastening parts and respectively supporting the pair of fastening protrusions in the fully fastened state.

An exercise assistance device according to an embodiment may include a waist frame worn on a waist of a user, a first waist belt connected to one side of the waist frame and covering a front side of the waist of the user, a second waist belt connected to the other side of the waist frame and covering a front side of the waist of the user, a buckle plug connected to the first waist belt, and a buckle socket including a pair of guides connected to the second waist belt and guiding the buckle plug in one direction, a pair of intermediate fastening parts respectively extending from the pair of guides and engaged with the buckle plug, a pair of fully fastening parts respectively extending from the pair of intermediate fastening parts and engaged with the buckle plug, wherein the buckle plug switches its state between an intermediate fastened state engaged with the pair of intermediate fastening parts and a fully fastened state engaged with the pair of fully fastening parts, a length of the first waist belt is adjustable in the intermediate fastened state, and the first waist belt is pressed by the buckle socket and the buckle plug in the fully fastened state.

In addition, the features of the embodiments described above may be combined unless this is technically and clearly infeasible.

Although the embodiments have been described with reference to the limited drawings, one of ordinary skill in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

1. An exercise assistance device comprising:
a waist frame configured to be worn on a waist of a user;
a first waist belt connected to a first side of the waist frame and configured for covering at least part of a front side of the waist of the user;
a second waist belt connected to another side of the waist frame and configured for covering at least part of a front side of the waist of the user;
a force transmission frame configured for covering at least part of a front side of a thigh of the user;
a thigh belt connected to the force transmission frame and configured for at least partially surrounding the thigh of the user;
an actuator, comprising a motor and/or a gear, connected to the waist frame and configured for generating power;
a driving frame connected to the actuator and configured for transmitting at least part of the power to the force transmission frame;
a buckle plug connected to the first waist belt; and
a buckle socket connected to the second waist belt,
wherein the buckle plug is configured to move in a first direction in which the buckle plug is inserted into the buckle socket, and to switch its state between an intermediate fastened state in which the buckle plug is engaged at a first position of the buckle socket and a fully fastened state in which the buckle plug is engaged at a second position of the buckle socket provided at a position apart from the first position in the first direction.

2. The exercise assistance device of claim 1,
wherein the buckle plug comprises:
a plug base;
a pair of plug arms respectively extending in parallel from both ends of the plug base;
a holder provided in parallel to the plug base and supporting the first waist belt;
a pair of hooks respectively extending from the pair of plug arms; and
a pair of fastening protrusions respectively protruding from the pair of hooks and fastened to the buckle socket.

3. The exercise assistance device of claim 2,
wherein the first waist belt is configured to pass between the plug base and the holder and surround the holder.

4. The exercise assistance device of claim 2,
wherein the buckle socket comprises:
a pair of guides configured for guiding the buckle plug to move in the first direction;
a pair of intermediate fastening parts respectively extending from the pair of guides and respectively configured for supporting the pair of fastening protrusions in the intermediate fastened state; and
a pair of fully fastening parts respectively extending from the pair of intermediate fastening parts and respectively configured for supporting the pair of fastening protrusions in the fully fastened state.

5. The exercise assistance device of claim 4,
wherein the device is configured so that a distance between the pair of guides decreases toward the first direction.

6. The exercise assistance device of claim 4,
wherein the buckle socket further comprises:
a base frame; and
a cover frame disposed on an opposite side of the base frame based on the pair of hooks, when the buckle plug is in the fully fastened state.

7. The exercise assistance device of claim 6,
wherein the pair of guides, the pair of intermediate fastening parts, and
the pair of fully fastening parts are provided on at least one of the base frame and the cover frame.

8. The exercise assistance device of claim 6,
wherein the base frame comprises:
a base body connected to the cover frame; and
a pressing plate extending from the base body in a second direction, which is a direction opposite to the first direction.

9. The exercise assistance device of claim 8,
wherein, in the fully fastened state, the pressing plate is configured to guide the first waist belt, which passes between the pressing plate and the plug base, in the second direction.

10. The exercise assistance device of claim 8,
wherein a distance between the pressing plate and the plug base in the intermediate fastened state is greater than a distance between the pressing plate and the plug base in the fully fastened state.

11. The exercise assistance device of claim 8,
wherein, in the fully fastened state, a distance between the pressing plate and the plug base is less than twice a thickness of the first waist belt.

12. The exercise assistance device of claim 8,
wherein the buckle plug comprises:
a support rib connected to the pair of plug arms and provided on an opposite side of the plug base based on the holder; and
a center bar extending from the support rib in a direction parallel to the pair of plug arms.

13. The exercise assistance device of claim 12,
wherein the first waist belt comprises an inner belt passing between the support rib and the holder and an outer belt passing between the holder and the plug base, based on a point supported by the holder, and
in the fully fastened state, a distance between the pressing plate and the plug base is less than a sum of a thickness of the inner belt and a thickness of the outer belt.

14. The exercise assistance device of claim 12,
wherein, in the fully fastened state, the support rib is supported by the buckle socket.

15. The exercise assistance device of claim 1,
wherein, in the intermediate fastened state, a length of the first waist belt is adjustable, and in the fully fastened state, the first waist belt is pressed by the buckle socket and the buckle plug.
